(19) United States
(12) Patent Application Publication
(10) Pub. No.: US 2016/0035000 A1
(43) Pub. Date: Feb. 4, 2016

(54) SYSTEM AND METHOD FOR PROVIDING AN INSTANT STYLIST

(71) Applicant: Shelly Xu, New York, NY (US)

(72) Inventor: Shelly Xu, New York, NY (US)

(21) Appl. No.: 14/447,725

(22) Filed: Jul. 31, 2014

(51) Int. Cl. G06Q 30/06

(52) U.S. Cl. CPC G06Q 30/0631; G06Q 30/0643

(57) ABSTRACT

A system and method for providing an instant stylist is provided. In example embodiments, a trigger to initiate generation of a product combination is received from a user device. The trigger may include a user preference of a user operating the user device. Style data is accessed. The style data provides guidelines indicating compatible attributes of item combinations derived from source data. Based on the user preference and the style data, the product combination is generated by matching attributes of products using the guidelines indicating the compatible attributes of item combinations. The product combination is output in a results user interface.

### FIELD

The present disclosure relates generally to data analysis and, in a specific example embodiment, to providing an instant stylist.

### BACKGROUND

Typically, high-end retailers spend exorbitant amount of time, energy, and resources putting together outfits or combinations of products that go well together. In most cases, the retails hire stylists/creative directors to produce the combinations. While the process is time consuming, it tends to be manual rather than creative. The stylists usually base the combinations strictly on the season's trends (e.g., based on runway shows) as well as the products for the particular retailer, designer, or brand in order to construct hundreds of outfits over a short period of time (e.g., a week). As a result, the stylist may have to go through hundreds of products every day to pair up products to create the combinations. This is a tedious, disorganized process that slows down an entire workflow.

### BRIEF DESCRIPTION OF DRAWINGS

Various ones of the appended drawings merely illustrate example embodiments of the present invention and cannot be considered as limiting its scope.

FIG. 1 is a block diagram illustrating an example embodiment of a network architecture of a system used to provide an instant stylist.

FIG. 2 is a block diagram illustrating an example embodiment of a stylist system.

FIGS. 3A-3E are example user interfaces providing the instant stylist.

FIGS. 4A-4D are further example user interfaces providing the instant stylist.

FIG. 5 is a flow diagram of an example method for creating style data.

FIG. 6 is a flow diagram of an example method for generating combinations using the stylist system.

FIG. 7 is a flow diagram of another example method for generating combinations using the stylist system.

FIG. 8 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for providing an instant stylist. The instant stylist comprises a system that makes style recommendations by generating product combinations based on styles or trends. In example embodiments, a trigger to initiate generation of a product combination is received from a user device. The trigger may include a user preference of a user operating the user device. Style data is accessed. The style data provides guidelines indicating compatible attributes of item combinations derived from source data. Based on the user preference and the style data, the product combination is generated by matching attributes of products using the guidelines indicating the compatible attributes of item combinations. The product combination is output in a results user interface.

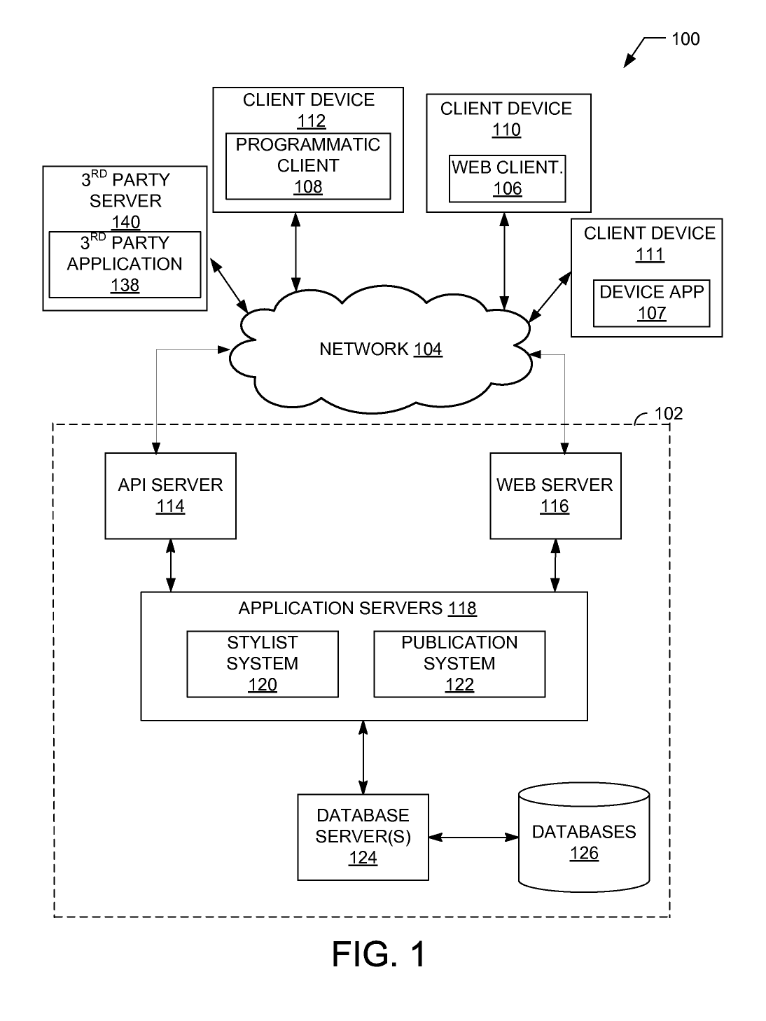

With reference to FIG. 1, an example embodiment of a high-level client-server-based network architecture 100 to provide an instant stylist is shown. A networked system 102, in an example form of a network-server-side functionality, is coupled via a communication network 104 (e.g., the Internet, wireless network, cellular network, or a Wide Area Network (WAN)) to one or more client devices 110-112. FIG. 1 illustrates, for example, a web client 106 operating via a browser (e.g., such as the INTERNET EXPLORER® browser developed by Microsoft® Corporation of Redmond, Wash. State), a device application 107, and a programmatic client 108 executing on respective client devices 110-112.

The client devices 110-112 may each comprise a mobile phone, desktop computer, laptop, or any other communication device that a user may utilize to access the networked system 102. In some embodiments, each client device (e.g., client device 110) may comprise a display module (not shown) to display information (e.g., in the form of user interfaces). In further embodiments, the client device may comprise one or more of a touch screen, accelerometer, camera, microphone, and Global Positioning System (GPS) device. The client devices 110-112 may be a device of a user, which is used to trigger processing of information, provide preferences and user inputs, and receive results from an instant stylist system provide by the networked system 102. In one embodiment, the networked system 102 includes or is linked to a network-based marketplace that manages digital goods, publishes publications comprising product listings of products available on the network-based marketplace, and manages payments for these marketplace transactions.

An Application Program Interface (API) server 114 and a web server 116 are coupled to, and provide programmatic and web interfaces respectively to, one or more application servers 118. The application servers 118 host a stylist system 120 and a publication system 122, each of which may comprise one or more modules, applications, or engines, and each of which may be embodied as hardware, software, firmware, or any combination thereof. The application servers 118 are, in turn, coupled to one or more database servers 124 facilitating access to one or more information storage repositories or databases 126. In one embodiment, the databases 126 are storage devices that store source data (e.g., style and trend information such as from runway shows), style data (e.g., extracted and weighted source information), product data (e.g., for a particular brand or manufacturer) and information to be posted (e.g., publications or listings) to the publication system 122.

In example embodiments, the publication system 122 publishes content on a network (e.g., Internet). As such, the publication system 122 provides a number of publication and marketplace functions and services to users that access the networked system 102. In example embodiments, the publication system 122 is a marketplace environment whereby a user may purchase products listed thereon. However, it is noted that the publication system 122 may, in alternative embodiments, be associated with a non-marketplace environment such as an informational (e.g., search engine) or social networking environment.

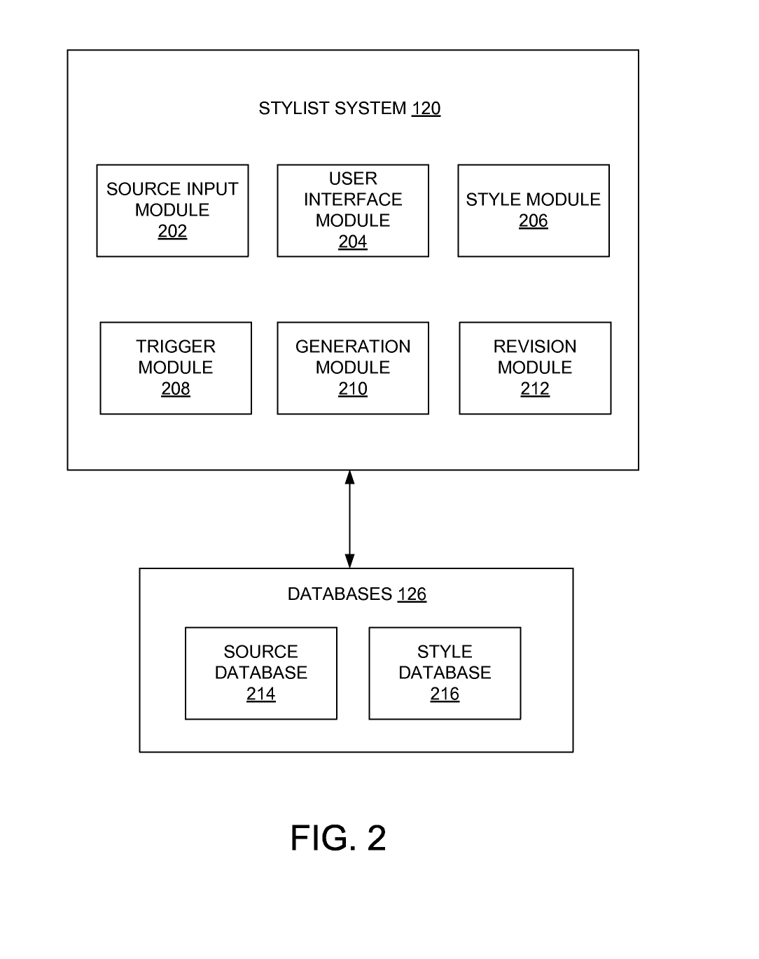

The stylist system 120 functions as an instant stylist. As such, the stylist system 120 takes in source data indicating styles and trends (e.g., information associated with runway shows) along with brand and product information. The stylist system 120 analyzes the source data to train itself to the styles and trends. Based on user preferences and inputs, the stylist system 120 may then create product combinations (e.g., outfits) based on the styles and trends derived from the source data. The stylist system 120 will be discussed in more detail in connection with FIG. 2 below.

While the stylist system 120 and the publication system 122 are shown in FIG. 1 to both form part of the networked system 102, it will be appreciated that, in alternative embodiments, the stylist system 120 or the publication system 122 may form part of a separate service that is distinct from the networked system 102. Additionally, while the example network architecture 100 of FIG. 1 employs a client-server architecture, a skilled artisan will recognize that the present disclosure is not limited to such an architecture. The example network architecture 100 can equally well find application in, for example, a distributed or peer-to-peer architecture system. The stylist system 120 and publication system 122 may also be implemented as standalone systems or standalone software programs operating under separate hardware platforms, which do not necessarily have networking capabilities. For example, the stylist system 120 along with the databases 126 may be entirely on the client device (e.g., client device 111), or the stylist system 120 may be on the client device and have access to the separate databases 126.

Referring now to FIG. 2, an example block diagram illustrating multiple components that, in one embodiment, are provided within the stylist system 120 is shown. The stylist system 120 performs operations that provide an instant stylist. To enable these operations, the stylist system 120 comprises a source input module 202, a user interface module 204, a style module 206, a trigger module 208, a generation module 210, and a revision module 212. The multiple components themselves are communicatively coupled (e.g., via appropriate interfaces), either directly or indirectly, to each other and to various data sources (e.g., the databases 126), to allow information to be passed between the components or to allow the components to share and access common data. As shown, the stylist system 120 is coupled to, and exchanges information with, the databases 126. The databases 126 include a source database 214 and a style database 216.

The source input module 202 manages the receipt of source data. Source data comprises style and trend information received from various sources. In one embodiment, the source data includes runway show information received from a runway show source. The runway show information may include images of items and item combinations, as well as attribute information such as style, texture, size, or fit of each item. As such, for each runway look (e.g., item combination), the stylist system 120 can identify how items are matched for the look. In one example, each image of a runway look includes metadata that provides the attribute information.

Alternatively, each runway look may have accompanying source filenames that indicate the attribute information. Accordingly, each source filename may comprise a code whereby each letter, number, or sets of letter or numbers, indicate an attribute of the item. For example, for each source filename (e.g., C602875), a letter may indicate texture, a first two digits indicates a style, a next two digits indicates a color, and a next two digits indicates a fit. Any combination of letters and numbers may be used to establish a source filename or indicate various attributes of the item, and any number of attributes may be indicated by the source filename. Along with the source filenames for item combinations, the source data may also include code keys that indicate what letters, digits, and positions of letters and digits in the source filenames represent.

In other embodiments, the source data may comprise a mock up by the user. In these embodiments, the user can create a runway look or a runway show by manually selecting items to create item combinations. The item combinations are then stored as additional source data that may be used to train the stylist system 120. The source data is stored to the source database 214.

The user interface module 204 provides various user interfaces for display on a user device of the user. The user interfaces may include, for example, an input user interface, a source user interface, and a results user interface. Each of these interfaces will be discussed in more detail below.

The style module 206 creates the style data that will be used by the generation module 210 in creating product combinations (e.g., outfits). The style data provides guidelines indicating compatible attributes of item combinations derived from the source data. Accordingly, the style module 206 analyzes the source data and determines colors, textures, styles, accessories, patterns, or other attributes that go together. Using the source filenames of the items from the source data, attributes of items that are combined together to create a particular runway look may be identified by the style module 206. For example, the source data may include a runway look where a model is wearing a blue, boat-neck top with khaki shorts and a gold chain necklace. The style data determined by this runway look may indicate that a blue item tends to match with a neutral colored item (e.g., a first color attribute pairs with a second color attribute) and a heavy piece of metal jewelry tends to match with a particular style top (e.g., accessory attribute pairs with a style attribute). While only two attributes are paired in this example, any number or types of attributes may be grouped together to create distinctive style guidelines for the style data.

In some embodiments, the user may weigh the various items or item combinations. Accordingly, the user interface module 204 provides a source user interface to a device of the user. The source user interface may provide fields where the user enters percentages or weights to emphasize or deemphasize a particular runway look. The weighting is used by the style module 206 to create and adjust the style guidelines of the style data. Additionally, if multiple runway looks have the same or similar attribute pairs or attribute groupings, the corresponding style guidelines may be weighted higher than other runway looks which are less prominent. The style data is stored to the style database 216.

The trigger module 208 manages the activation of the stylist system 120 for purposes of generating product combinations. In example embodiments, the trigger module 208 receives a trigger from a user device, whereby the trigger may include one or more user preferences or inputs. In one embodiment, the user preference comprises a product list that includes a plurality of products from which the product combinations are to be generated. The product list may be uploaded to the stylist system 120, for example, as an Excel spreadsheet or in another data format. In some cases, the product list may include images of each product or a link to images for the products. In other cases, images of the products may already be stored at the database (e.g., databases 126). In another embodiment, the user preference may comprise a price range, a product that the user is interested in, a mood of the user, gender, age, or other settings.

In some embodiments, product information may already be stored in the databases 126, and as such, the product list need not be uploaded. For example, the publication system 122 may store listings for various products (also referred to as a “product list”) that may be available for purchase on the publication system 122. Each product listing includes attributes for the product shown in the product listing.

In some embodiments, each product on the product list may have a product filename. Similar to the source filename, each product filename may comprise a code whereby each letter, number, or sets of letter or numbers, indicates an attribute of the product. For example, for each product filename, a letter may indicate texture, a first two digits indicates a style, a next two digits indicates a color, and a next two digits indicates a fit. Any combination of letters and numbers may be used to establish a product filename or indicate various attributes of the product, and any number of attributes may be coded into the product filename.

The generation module 210 generates a product combination based on matching attributes of products based on the style data. The generating of the product combination may take into consideration any user preferences indicated by the user. In example embodiments, the generation module 210 may access product filenames for products on the product list. The generation module 210 also accesses the style data to determine attributes of item combinations of styles identified from the style data. The generation module 210 then generates the product combination by identifying product attribute combinations that match item attribute combinations identified from the style data. For example, if the item attribute combination indicates that a blue colored item pairs well with a neutral colored item that has a linen texture, then the product combination may combine products that have attributes or blue color, neutral color, and linen texture. As a result, the product combination may be a blue v-neck top with a khaki pair of linen shorts. If a further item attribute combination indicates that a blue colored item pairs well with heavy metal jewelry, and that heavy metal jewelry pairs well with a boat-neck style top, then the product combination may, instead, be a blue boat-neck top paired with khaki pair of linen shorts along with a gold chain necklace. It is noted that any number of style data guidelines (e.g., item attribute combinations) may be combined to create a single product combination. The user can also add restrictions to customize the product combinations generated (e.g., only use July products, no accessories).

The generation module 210 may recursively generate a plurality of product combinations. For example, the user may specify in the user preferences that a certain amount of the products on the product list should be used to generate the product combination. Alternatively, the user may specify in the user preferences a number of product combinations that the user wants created. Further still, the user may indicate in the user preferences whether products not included in the product list, but known to the stylist system 120 (e.g., stored in the databases 126) may be included in generating the product combinations.

The generated one or more product combinations are output in a results user interface. In one embodiment, results (e.g., product combinations) displayed on the results user interface may include a composite image of the product combination that is created by combining the individual images of the products in the product combination. In another embodiment, the results may be output in a spreadsheet.

In some embodiments, the results may include a link to purchase one or more products in the product combination. By selecting the link, the user will be redirected to a product listing to purchase the product.

The results displayed on the results user interface may also include selectable features that allow the user to revise, delete, or annotate the product combinations. For example, the user can review the results and make comments about certain styles (e.g., indicate whether the products should actually be paired), and can send the results to a creative director for review. In another example, the user may determine that a product combination will not work and can delete the product combination from a result set. Further still, the user may decide to switch one item for another in a product combination. The various annotations, revisions, and deletions are received, executed, and managed by the revision module 212.

Although the various components of the stylist system 120 have been defined in terms of a variety of individual modules and engines, a skilled artisan will recognize that many of the components can be combined or organized in other ways and that not all modules or engines need to be present or implemented in accordance with example embodiments. Furthermore, not all components of the stylist system 120 have been included in FIG. 2. In general, components, protocols, structures, and techniques not directly related to functions of exemplary embodiments have not been shown or discussed in detail. The description given herein simply provides a variety of exemplary embodiments to aid the reader in an understanding of the systems and methods used herein.

In order to illustrate embodiments of the present invention, example embodiments are discussed herein with reference to clothing and accessories and combining these types of products to create outfits. However, example embodiments may be applicable to other types of products so long as guidelines for combining these other types of products based on attributes are derived from source data comprising item combinations that are used to train the system.

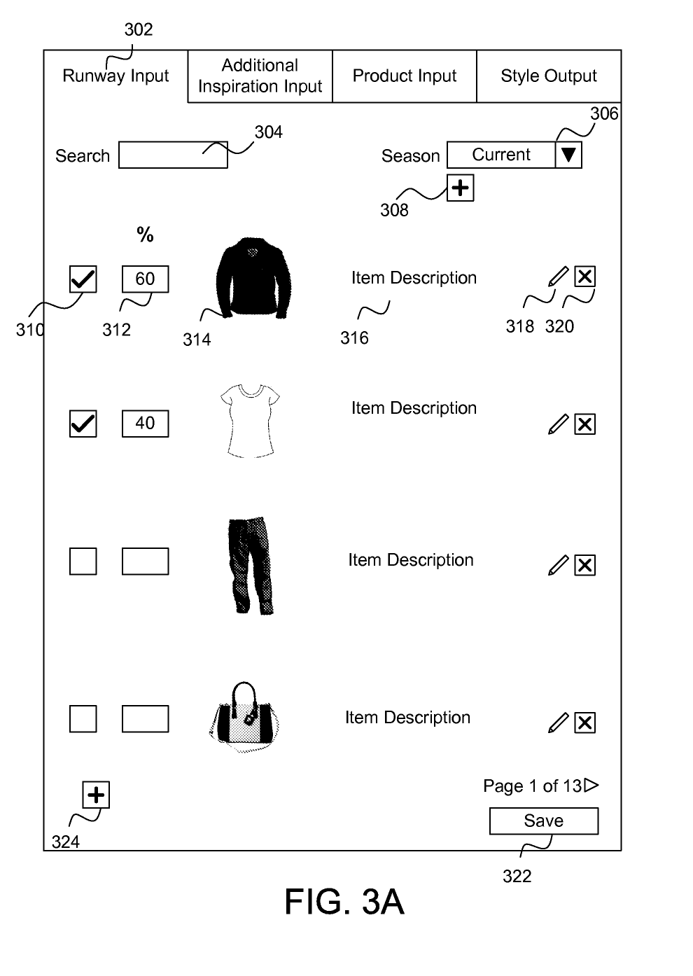

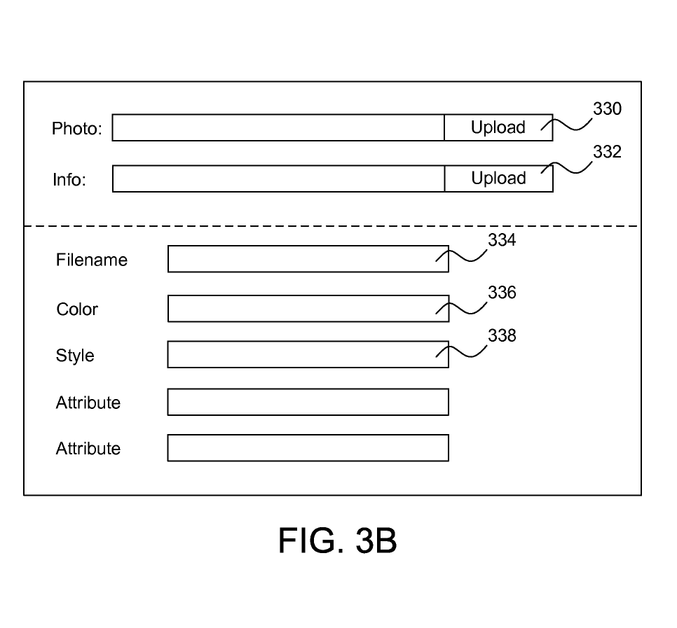

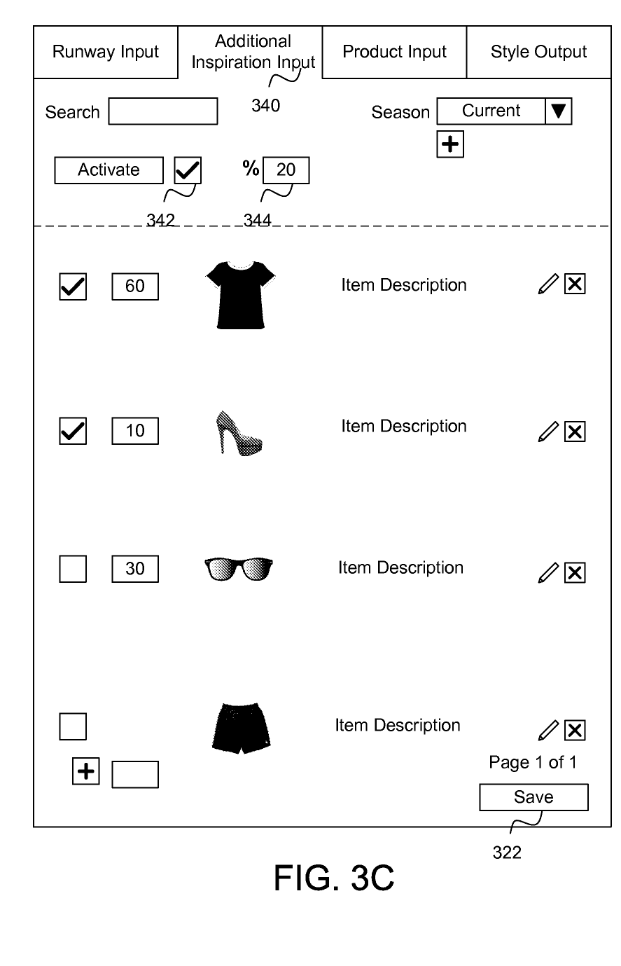

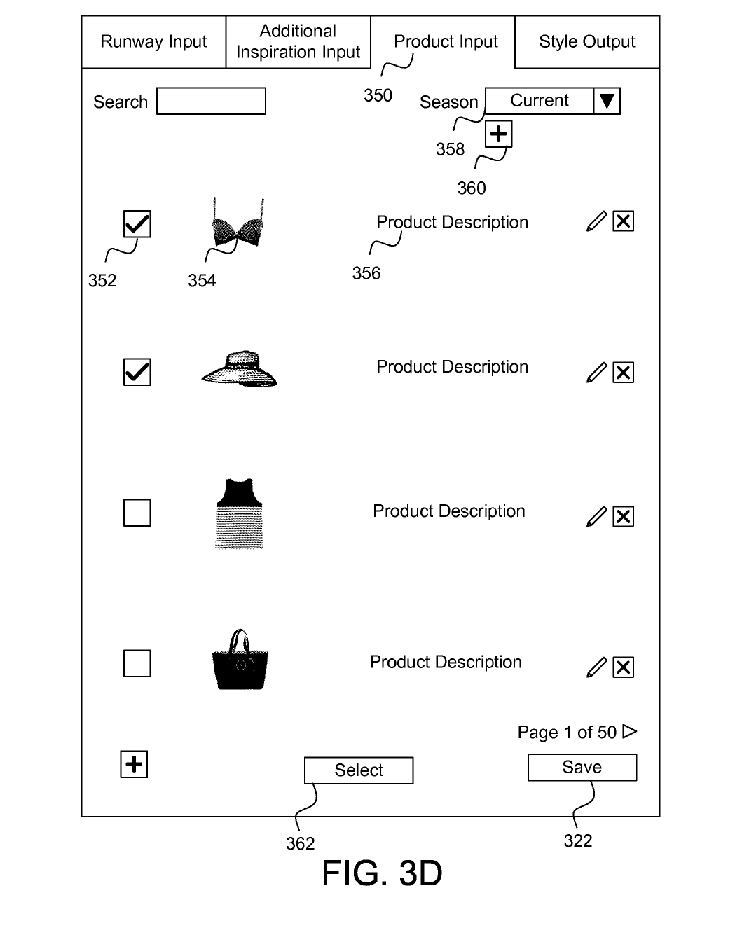

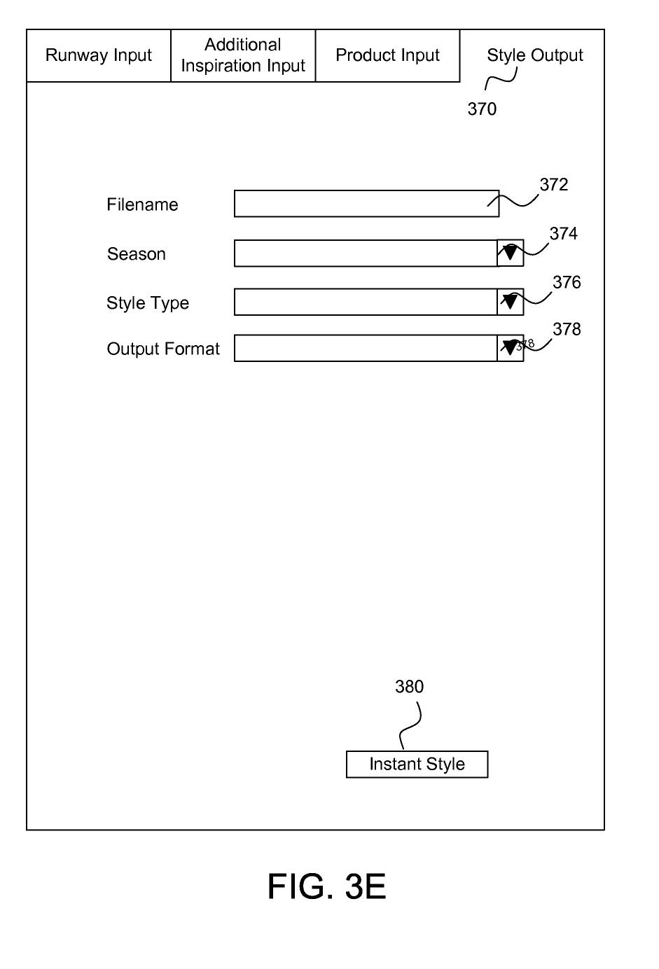

FIGS. 3A-3E are user interfaces providing the instant stylist according to one example embodiment. Based on a selection of a source tab (e.g., runway input tab 302), a source user interface as shown in FIG. 3A is presented to the user. The source user interface allows the user to provide preferences that will train the stylist system 120 (e.g., determine the style trends that will be taken into account in generating the product combinations). In one embodiment, the items shown on each “page” of the source user interface may constitute a single runway look. Alternatively, the items shown on each “page” may be items from one or more runway shows in a particular sorted order. In some cases, the user may search for particular items using a search field 304. The user may also indicate a season for the source data using a season drop down menu 306. Alternatively, the user may add a new season by selecting an add feature 308.

In example embodiments, the user may indicate which items should be considered when creating the style data (e.g., which items are a part of a “trend” for the indicated season) that will be used to generate the product combinations. The user may select items to be included in generating the style data by selecting a check box 310 next to the selected item(s). The user may also assign a weight to each selected item in a weight field 312. The weight may indicate a scale of importance of the item in generating the style data. An image 314 and an item description 316 may also be shown for each item. The user may edit the item (e.g., edit item description) by selecting an edit feature 318. Further still, the user may delete an item by selecting a delete feature 320. Deleting an item will remove the item completely from the source data. At any time, the user may save changes that they have made by selecting the save feature 322.

In example embodiments, the user may also upload an additional runway look by selecting a second add feature 324. By activating the second add feature 324, an upload user interface is presented to the user. FIG. 3B illustrates one example of the upload user interface. The upload user interface provides fields through which the user can add one or more new runway looks (e.g., source data) that will be analyzed to create the style data. For instance, the user may search for or upload a photo of the additional runway look via a photo field 330. The user may also upload runway look information or description (e.g., from a spreadsheet) for the additionally runway look in an info upload field 332. Alternatively, the user may manually input the runway look information by entering a source filename in a filename field 334. Attributes may also be entered in addition to, or in lieu of, the source filename such as a color in a color field 336, a style in a style field 338, or other attributes of the item. Any number of attributes may be entered in various embodiments.

Referring now to FIG. 3C, a second source user interface is presented. The second source user interface is presented in response to selection of an additional inspiration input tab 340. The selection of the additional inspiration input tab 340 causes an activate field 342 to be presented that when selected will take into account looks in addition to runway looks stored as source data (e.g., mock runway looks, individually selected items). The user may specify a weight to be applied to the additional inspiration input in a weight field 344. The user may save the user inputs at any time by selecting the save feature 322. Shown below the activate field 342 are the additional inspiration inputs from which the user may select one or more items and assign a weight. The user may also revise the item descriptions or delete the items.

FIG. 3D illustrates an example of a product input user interface. When the user selects a product input tab 350, the product input user interface is presented which shows products that may be used for creating the product combinations (e.g., creating new outfits). In example embodiments, the user may indicate which products should be considered when generating the product combinations. The user may select products to be used by selecting a check box 352 next to the selected product. An image 354 and a product description 356 may also be shown for each product. The user may select products from a particular season using a season dropdown field 358 or a manual season input feature 360. At any time, the user may save changes that they have made by selecting the save feature 322.

In one embodiment, the products shown on the product input user interface are from a product list uploaded to the stylist system 120. The user may upload the product list by activating a select feature 362. Activation of the select feature 362 allows the user to upload a spreadsheet (e.g., Excel spreadsheet) of product filenames to be selected from in generating the product combinations. The spreadsheet may also include code keys that indicate what letters, digits, and positions of letters and digits in the product filenames represent.

Based on a selection of a style output tab 370, an output user interface may be presented. FIG. 3E is an example of the output user interface. In the example of FIG. 3E, the output user interface receives user preferences for use in generating the product combinations. For example, the user may provide an output filename for an output file that will be created containing the one or more product combinations. The output filename may be entered in a filename field 372. The user may also indicate a season (e.g., current, spring, summer) to use in generating the product combinations by using a season dropdown menu 374.

Additionally, the user may indicate the styling type to be used in generating the product combination in a styling type dropdown menu 376. Styling type may include, for example, basic exclusive, basic, and advanced. The basic exclusive styling type will only use the products selected by the user (e.g., selected in the product user interface of FIG. 3D) in generating the product combination. The basic styling type will use selected clothing products (e.g., selected in the product user interface of FIG. 3D) in addition to accessories that may not have been selected from the product list. The advanced styling type provides more options to the user whereby the user may upload or type in specific guidelines or requirements to be used in creating the product combinations. Other style types may be used.

The user may also specify an output format for the output file in a format dropdown menu 378. For example, the user may create an output file in an Excel format, comma-separated values (CSV) format, or any other format. Once all the selections have been made, the user may trigger generation of the product combinations by selecting an instant style feature 380.

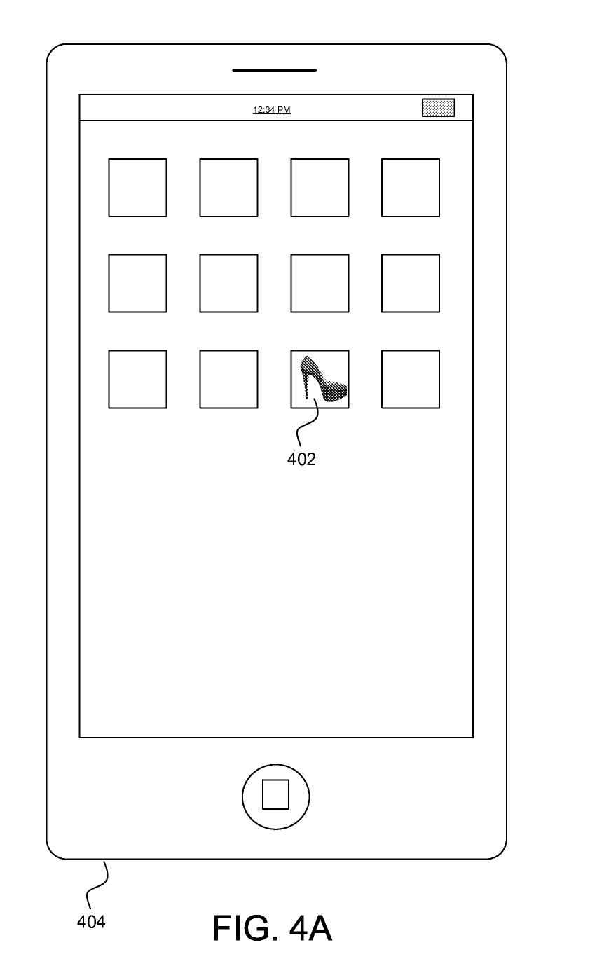

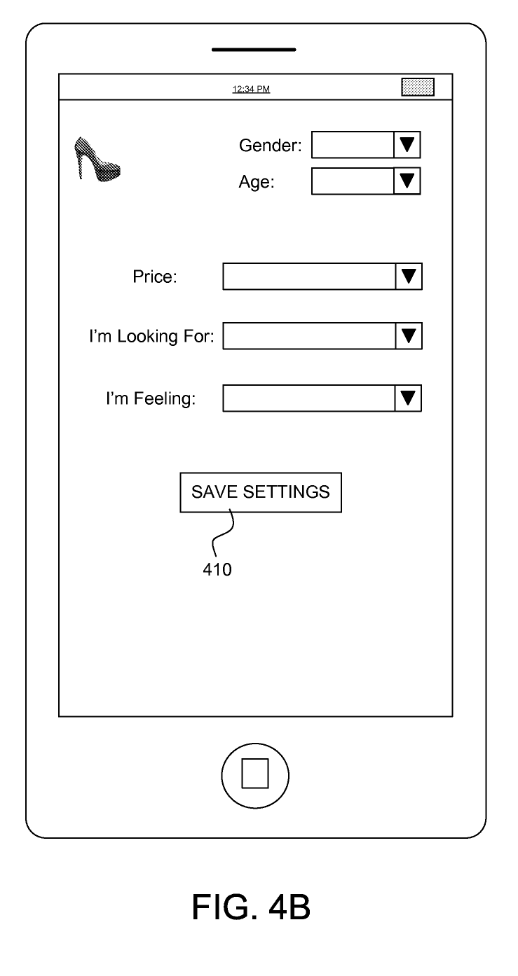

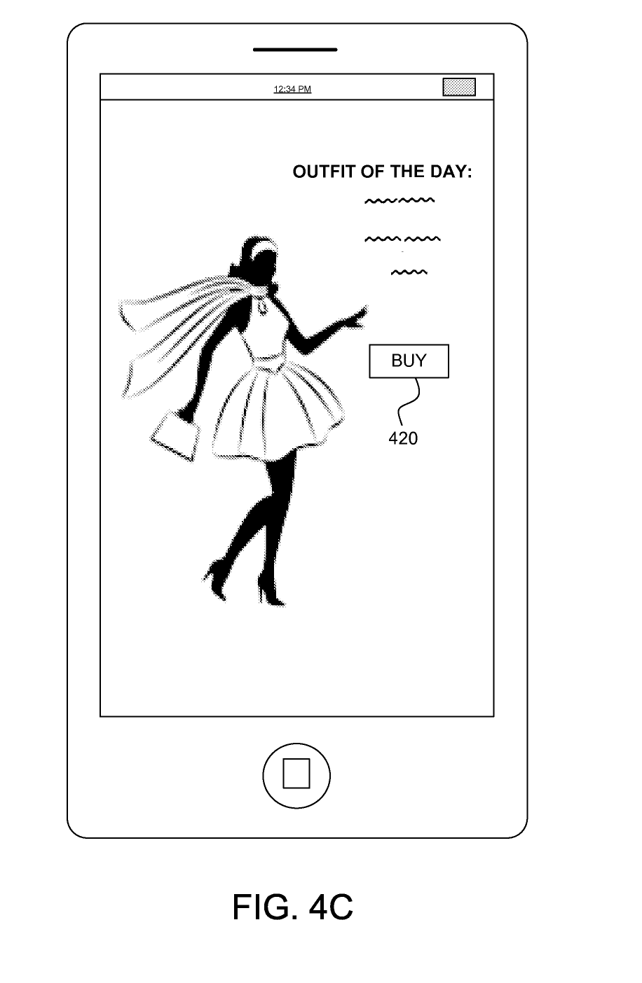

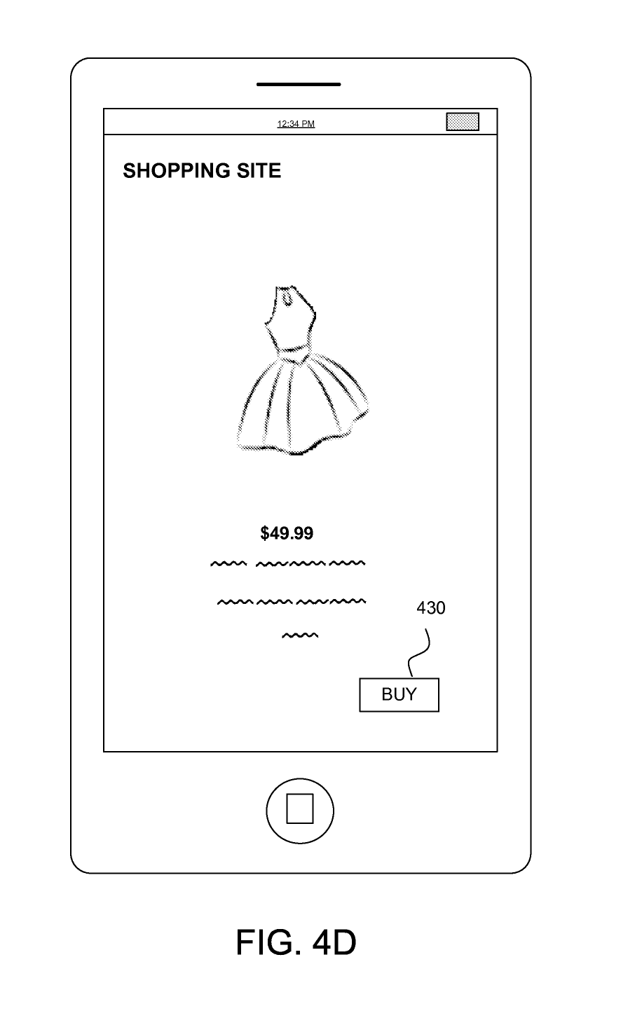

FIGS. 4A-4D are further example user interfaces providing the instant stylist on a user device. The example user interfaces of FIG. 4A-4D may be provided to a user that is an individual consumer accessing the functionalities of the stylist system 120 through an application on their user device. For example, the user may be accessing the functionalities of the stylist system 120 through a mobile application 402 on their mobile device 404 as shown in FIG. 4A.

Upon activation of the mobile application 402, an input user interface is presented to the user. The input user interface provides fields where the user may enter user preferences. For example, the user may indicate their gender, age, a price range, a product the user is interested in (e.g., a particular article of clothing such as a dress, shoes, bags), and a mood of the user (e.g., classy, flowery, heading to a party, business-like) as shown in FIG. 4B. Other user inputs or preferences may be included or used instead of, or in addition to, the user preferences shown in FIG. 4B. In some cases, some of the fields may be prepopulated based on past uses by the user (e.g., gender and age). The fields may be filled in by selecting from a dropdown menu. Alternatively, the user may manually input values in the fields. As an example, the user may enter that she is female, 28 years old, has a price range of $25-$50, is looking for a dress, and is heading to a party.

Once the settings (e.g., user preferences) are selected, the user may save the preferences and trigger the stylist system 120 to generate a product combination by selecting a save settings feature 410. In response, the stylist system 120 takes the user preferences and determines compatible attributes that corresponding to the user preferences. For example, heading to a party may indicate attributes such as color should be black, red, or white; a dress for a party may indicate a style attribute that is above the knee; shoes for a party should have a style attribute that includes heels, and so forth.

Using these attributes, the stylist system 120 generates a product combination for the user. For instance, the stylist system 120 accesses a product list (e.g., database of the publication system 122) and determines products and product combinations having matching attributes to the style data (e.g., compatible attributes). The stylist system 120 (e.g., generation module 210) may also accesses product data for the products in product combination, retrieves corresponding images, and creates a composite image that represents the product combination. The composite image may be displayed on a results user interface as shown in FIG. 4C.

The results user interface may also include a description of the product combination and a link 420 to purchase one or more of products of the product combination. In the present example, since the user indicated that she was interested in a dress, activation of the link 420 redirects the user to a product listing for the dress as shown in FIG. 4D. The product listing may include more information on the product as well as a price and a buy feature 430 to purchase the product.

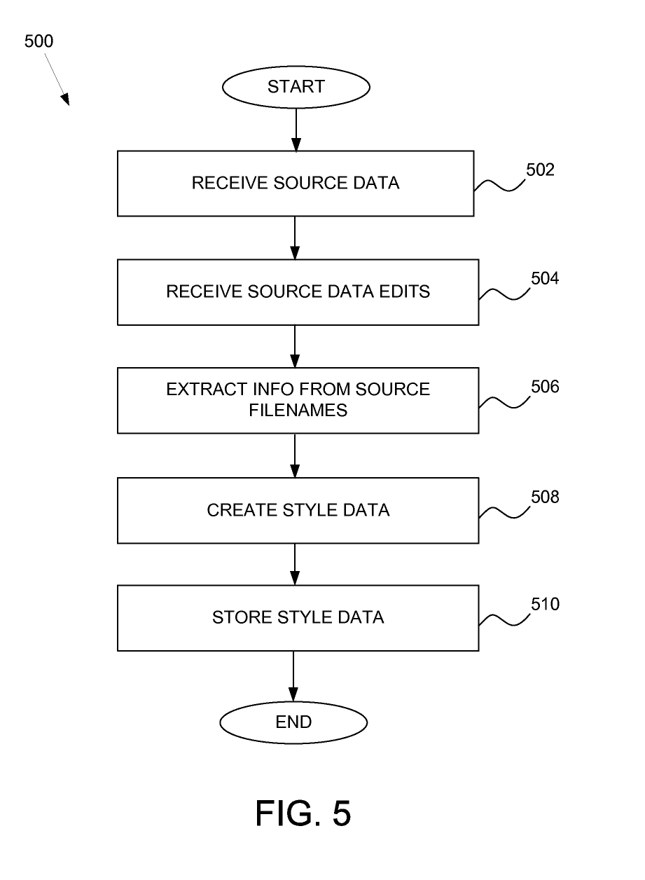

FIG. 5 is a flow diagram of an example method 500 for creating style data that will be used to generate product combinations. In operations 502, source data is received by the source input module 202. The source data comprises style and trend information received from various sources such as runway shows or mock looks created by a user. The source data is then used to “train” the stylist system 120 to particular styles or trends for a particular period of time (e.g., season). The source data may include images of items and items combinations, as well data such as style, texture, size, fit, or other attributes of each item and item combination. In some embodiments, the attribute data may be derived from a source filename for each item in the source data. As such, a code key that is used for deriving the source filenames may also be included in the source data.

Source data edits are received in operation 504. In example embodiments, the user interface module 204 provides a source user interface to a device of the user. The source user interface may provide fields where the user enters percentages or weights to emphasize or deemphasize a particular runway look or item. The user may also delete items from the source data, or not select particular items to be included in a style analysis to generate the style data. The weighting is used by the style module 206 to create and adjust the style guidelines of the style data (e.g., one particular attribute combination may be weighted as being more important than another attribute combination).

Information may be extracted from the source filenames in operation 508. In example embodiments, the style module 206 analyzes the source data and determines colors, textures, styles, accessories, patterns, or other attributes that go together. Using the source filenames of the items from the source data, attributes of items that are combined together to create a particular runway look may be identified by the style module 206. As previously discussed, the source filenames of the items comprise a code that identifies attributes of the item (e.g., color, style, fit, texture). For example, the source data may include a runway look that indicates that a blue item tends to match with a neutral colored item, and a heavy piece of metal jewelry tends to match with a particular style top.

In operation 508, the style data is created. In example embodiments, the style module 206 creates the style data that will be used by the generation module 210 in creating product combinations (e.g., outfits). The style data provides guidelines indicating compatible attributes of items (e.g., attribute combinations) derived from the source data. Using the source data edits (e.g., indication of inclusion or exclusion of item, weighting), the style module 206 creates and adjusts the style guidelines of the style data. Additionally, if multiple runway looks have the same or similar attribute pairs or groupings, the corresponding style guidelines may be weighted higher than other runway looks which are less prominent. The style data is stored to the style database 216 in operation 510.

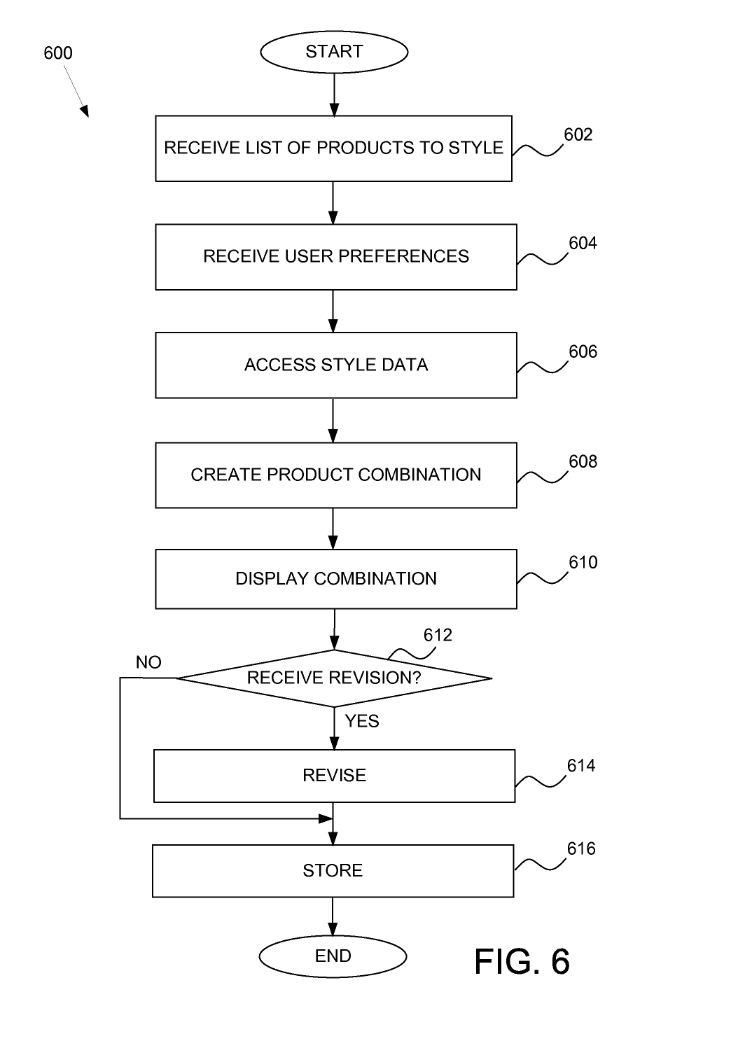

FIG. 6 is a flow diagram of an example method 600 for generating product combinations using the stylist system 120 in accordance with one embodiment. In operation 602, a list of products to be styled (e.g., product list) is received. In example embodiments, the trigger module 208 receives a trigger from a user device that includes the product list. The product list may be uploaded to the stylist system 120, for example, as a spreadsheet (e.g., Excel spreadsheet) or in another data format. In some cases, the product list may include images of each product or a link to images for the products. In other cases, images of the products may already be stored at the database (e.g., databases 126).

In operation 604, user preferences are received. In example embodiments, the trigger module 208 also receives the user preferences. The user preferences may indicate a particular season's styles and trends to apply, a style type to use, and an output format for results of the stylist system 120. In some embodiments, operations 602 and 604 may be combined within a single operation.

In operation 606, style data is accessed by the generation module 210 to determine attributes of item combinations of styles identified from the style data. Product combinations are then created in operation 608 by the generation module 210. The generation module 210 generates each product combination based on matching attributes of products based on item attribute combinations in the style data. In example embodiments, the generation module 210 may access product filenames for products on the product list. Using the style data, the generation module 210 generates the product combination by identifying product attribute combinations that match item attribute combinations identified from the style data. The generation module 210 may recursively generate a plurality of product combinations (e.g., until a certain amount of the products on the product list are used, a number of product combinations that the user wants created).

The generated one or more product combinations are displayed in a results user interface in operation 610. In one embodiment, the results (e.g., one or more product combinations) displayed include a composite image of the product combination that is created by compositing the individual images of the products in the product combination. In another embodiment, the results may be output in a spreadsheet.

In operation 612, a determination is made whether any revisions are received. The results user interface may include selectable features that allow the user to revise, delete, or annotate the product combinations. For example, the user can review the results and make comments about certain styles, determine that a product combination will not work and delete the product combination from a result set, or switch one item for another in a product combination. If a revision is received, then in operation 614, the revisions are executed. The results may then be stored in optional operation 616.

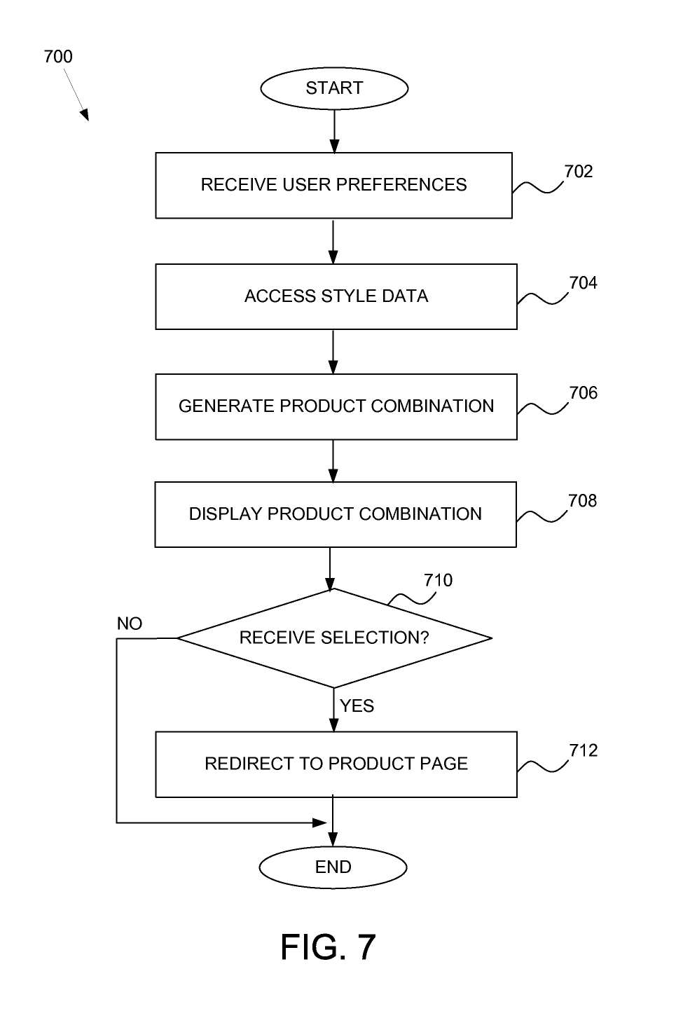

FIG. 7 is a flow diagram of another example method 700 for generating combinations using the stylist system 120 in accordance with an alternative embodiment. The method of FIG. 7 is directed to operations on a user device (e.g., mobile device) via an application installed thereon. The application may be initiated and user preferences received in operation 702. For example, the user may indicate their gender, age, a price range, a product the user is interested in (e.g., a particular article of clothing such as a dress, shoes, bags), and a mood of the user (e.g., classy, flowery, heading to a party, business-like). Once the settings (e.g., user preferences) are selected, settings are received by the stylist system 120.

In operation 704, the style data is accessed by the generation module 210 to determine attributes of item combinations of styles identified from the style data. A product combination is then created in operation 706 by the generation module 210. The generation module 210 generates the product combination based on matching attributes of products known to the generation module 210 (e.g., product list available from the publication system 122) based on the style data. In example embodiments, the generation module 210 may access product filenames or attributes for products found in the publication system 122 or other marketplaces (e.g., one or more retailers). Using the style data, the generation module 210 generates the product combination by identifying product attribute combinations that match item attribute combinations identified from the style data based on the user preferences.

In operation 708, the product combination is presented to the user. In one embodiment, the generation module 210 accesses the product data for the products in product combination, retrieves corresponding images, and creates a composite image that represents the product combination. The composite image may be displayed on a results user interface.

In operation 710, a determination is made as to whether a selection of the product combination is received. In example embodiments, the user may select a link to access more information regarding the products of the product combination or to purchase a product of the product combination.

If the selection is received, the user is redirected to a product page (e.g., displaying a product listing) for one or more of the products of the product combination. The product page may include more information on the product as well as a price and a buy feature to purchase the product.

According to various example embodiments, one or more of the methodologies described herein may facilitate creating instant styles (e.g., product combinations) based on an extraordinary amount of data. The methodologies described herein may also facilitate the creation of the instant styles in an efficient and expedited manner. When these effects are considered in aggregate, one or more of the methodologies described herein may obviate a need for certain efforts or resources that otherwise would be involved in creating the product combinations. Efforts expended by a user in creating the product combinations may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

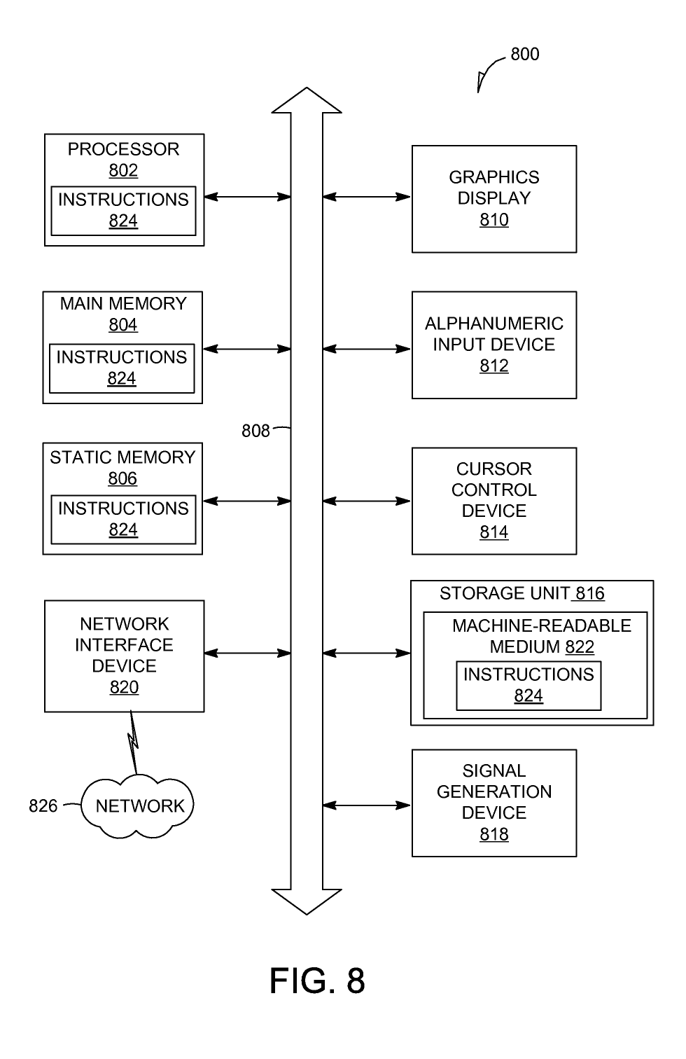

FIG. 8 is a block diagram illustrating components of a machine 800, according to some example embodiments, able to read instructions 824 from a machine-readable medium 822 (e.g., a non-transitory machine-readable medium, a machine-readable storage medium, a computer-readable storage medium, or any suitable combination thereof) and perform any one or more of the methodologies discussed herein, in whole or in part. Specifically, FIG. 8 shows the machine 800 in the example form of a computer system (e.g., a computer) within which the instructions 824 (e.g., software, a program, an application, an applet, an app, or other executable code) for causing the machine 800 to perform any one or more of the methodologies discussed herein may be executed, in whole or in part.

In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include a graphics display 810 (e.g., a plasma display panel (PDP), a light emitting diode (LED) display, a liquid crystal display (LCD), a projector, a cathode ray tube (CRT), or any other display capable of displaying graphics or video). The machine 800 may also include an alphanumeric input device 812 (e.g., a keyboard or keypad), a cursor control device 814 (e.g., a mouse, a touchpad, a trackball, a joystick, a motion sensor, an eye tracking device, or other pointing instrument), a storage unit 816, a signal generation device 818 (e.g., a sound card, an amplifier, a speaker, a headphone jack, or any suitable combination thereof), and a network interface device 820.

The storage unit 816 includes the machine-readable medium 822 (e.g., a tangible and non-transitory machine-readable storage medium) on which are stored the instructions 824 embodying any one or more of the methodologies or functions described herein. The instructions 824 may also reside, completely or at least partially, within the main memory 804, within the processor 802 (e.g., within the processor's cache memory), or both, before or during execution thereof by the machine 800. Accordingly, the main memory 804 and the processor 802 may be considered machine-readable media (e.g., tangible and non-transitory machine-readable media).

In some example embodiments, the machine 800 may be a portable computing device, such as a smart phone or tablet computer, and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 800), such that the instructions, when executed by one or more processors of the machine (e.g., processor 802), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 824 may further be transmitted or received over a communications network 826 using a transmission medium via the network interface device 820 and utilizing any one of a number of well-known transfer protocols (e.g., HTTP). Examples of communication networks include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving, from a user device, a trigger to initiate generation of a product combination, the trigger including a user preference of a user operating the user device;
accessing style data, the style data comprising guidelines indicating compatible attributes of item combinations derived from source data;
based on the user preference and the style data, generating the product combination, the generating comprising matching attributes of products using the guidelines indicating the compatible attributes of item combinations; and
outputting the product combination in a results user interface.

2. The method of claim 1, wherein the receiving the trigger comprises receiving an upload of a product list, the product list including a plurality of products from which the product combination is generated.

3. The method of claim 2, wherein the receiving the upload of the product list comprises receiving an upload of an Excel spreadsheet that identifies the plurality of products.

4. The method of claim 2, wherein each product on the product list is identified by a product filename, the product filename comprising a code that indicates attributes of the product.

5. The method of claim 1, further comprising receiving source data, the source data including source filenames of items that are grouped together to create a particular style, each source filename comprising a code that indicates attributes of a corresponding item.

6. The method of claim 5, wherein the source data is received from a selection from the group consisting of a runway show and a mockup look.

7. The method of claim 5, further comprising:
presenting a source user interface that illustrates the source data;
receiving, via the source user interface, weighting for one or more items of the source data; and
creating the style data based on the weighting of the one or more items of the source data.

8. The method of claim 1, wherein the generating the product combination comprises:
accessing product filenames for products on a list from which the product combination is generated, the product filenames each comprising a code that indicates attributes of each corresponding product on the list,
determining the compatible attributes of item combinations identified from the style data; and
combining products from the list based on the attributes of each corresponding product on the list, the combining comprising creating attribute combinations of products that match the compatible attributes of the item combinations identified from the style data.

9. The method of claim 1, wherein the outputting the product combination in the results user interface comprises creating an image of the product combination by integrating individual images of the products to create a composite image of the product combination.

10. The method of claim 1, wherein the outputting the product combination in the results user interface comprises providing selectable features on the results user interface, the selectable features including an annotation feature to receiving a user annotation and a deletion feature to delete a product from the product combination.

11. The method of claim 1, wherein the outputting the product combination in the results user interface comprises providing a link that redirects the user to a product listing to purchase a product of the product combination.

12. The method of claim 1, wherein the outputting the product combination in the results user interface comprises outputting a spreadsheet.

13. The method of claim 1, wherein the receiving the trigger comprises receiving, via an input user interface, at least one selection from the group consisting of a price range, a product that the user is interested in, a mood of the user, brand, gender, and age.

14. A machine-readable medium having no transitory signals and in storing instructions which, when executed by the at least one processor of a machine, cause the machine to perform operations comprising:
receiving, from a user device, a trigger to initiate generation of a product combination, the trigger including a user preference of a user operating the user device;
accessing style data, the style data comprising guidelines indicating compatible attributes of item combinations derived from source data;
based on the user preference and the style data, generating the product combination, the generating comprising matching attributes of products using the guidelines indicating the compatible attributes of item combinations; and
outputting the product combination in a results user interface.

15. The machine-readable medium of claim 14, wherein the receiving the trigger comprises receiving an upload of a product list, the product list including a plurality of products from which the product combination is generated, wherein each product on the product list is identified by a product filename, the product filename comprising a code that indicates attributes of the product.

16. The machine-readable medium of claim 14, wherein the operations further comprise:
receiving source data, the source data including source filenames of items that are grouped together to create a particular style, each source filename comprising a code that indicates attributes of a corresponding item.
presenting a source user interface that illustrates the source data;
receiving, via the source user interface, weighting for one or more items of the source data; and
creating the style data based on the weighting of the one or more items of the source data.

17. The machine-readable medium of claim 14, wherein the generating the product combination comprises:
accessing product filenames for products on a list from which the product combination is generated, the product filenames each comprising a code that indicates attributes of each corresponding product on the list,
determining the compatible attributes of item combinations identified from the style data; and
combining products from the list based on the attributes of each corresponding product on the list, the combining comprising creating attribute combinations of products that match the compatible attributes of the item combinations identified from the style data.

18. The machine-readable medium of claim 14, wherein the outputting the product combination in the results user interface comprises creating an image of the product combination by integrating individual images of the products to create a composite image of the product combination.

19. The machine-readable medium of claim 14, wherein the outputting the product combination in the results user interface comprises providing a link that redirects the user to a product listing to purchase a product of the product combination.

20. A system comprising:
one or more processors configured to include:
a trigger module to receive, from a user device, a trigger to initiate generation of a product combination, the trigger including a user preference of a user operating the user device;
a generation module to access style data, the style data comprising guidelines indicating compatible attributes of item combinations derived from source data, and to generate the product combination based on the user preference and the style data by matching attributes of products using the guidelines indicating the compatible attributes of item combinations; and
a user interface module to present a results user interface displaying the product combination.
